(19) United States
(12) Patent Application Publication
(10) Pub. No.: US 2012/0075759 A1
(43) Pub. Date: Mar. 29, 2012

(54) Safe Exposed Conductor Power Distribution System

(76) Inventor: Stephen Spencer Eaves, Charlestown, RI (US)

(21) Appl. No.: 12/911,710

(22) Filed: Oct. 25, 2010

Related U.S. Application Data
(60) Provisional application No. 61/255,463, filed on Oct. 27, 2009.

(51) Int. Cl. H02H 3/02

(52) U.S. Cl. 361/86

(57) ABSTRACT

A power distribution system that can detect an unsafe fault condition where an individual or object has come in contact with the power conductors. A block diagram of the present invention is shown in FIG. 1. The power distribution system regulates the transfer of energy from a source 1 to a load 3. Periodically, source controller 5 opens S1 disconnect switch 7 and load controller 9 opens S2 disconnect switch 13. A capacitor 4 represents that capacitance across the load terminals. If the capacitor discharges at a rate higher or lower than predetermined values after S1 and S2 are opened, then a fault condition is registered and S1 and S2 will not be commanded to return to a closed position, thus isolating the fault from both the source and load.

### CLAIM OF PRIORITY

This application claims priority to U.S. Ser. No 61/255,463 entitled “Safe Exposed Conductor Power Distribution System”, filed on Oct. 27, 2009, naming Stephen Eaves of Charlestown, R.I. as inventor, the contents of which are herein incorporated by reference in their entirety.

### FIELD OF INVENTION

This invention relates to power distribution system safety protection devices. More specifically, power distribution systems with electronic monitoring to detect and disconnect power in the event of an electrical fault or safety hazard; particularly where an individual has come in contact with exposed conductors. This invention is applicable to general power distribution, or more specifically electric vehicle charging systems, electric railway vehicle power distribution or energized roadways for electric vehicles.

### BACKGROUND

In a typical power distribution application, power from a central source is distributed through a number of branch circuits to a load device. The branch circuits are equipped with protection devices such as circuit breakers or fuses. During an electrical fault, such as a short circuit, the protection devices are designed to detect an abnormally high level of current and disconnect, or interrupt, the source from the load before causing damage or fire to the distribution system.

The introduction of the Ground Fault Interrupter (GFI) added electrocution protection to the distribution system by detecting an imbalance between phase currents in a particular branch circuit, indicating that current is flowing through an alternate ground path and possibly in the process of electrocuting an individual.

However, there are significant shortcomings in traditional distribution protection methods. For example, a fire could still occur from a loose connection. In this case, the resistance of a live connection increases and heats up to the point of igniting surrounding materials. This heat build-up could occur at electrical currents well below the trip point of the branch circuit protection devices. In the case of GFI protection, the GFI circuit can only protect an individual that comes in contact with both a line conductor and a ground point, such as would be the case if an individual touched a live electric conductor with one hand and a sink faucet with the other hand. However, if the individual manages to touch both a live conductor and a return path (such as across the “hot” and neutral conductors of a home outlet) the GFI would not activate and the person would receive a shock.

Another concept key to the background of the invention of this disclosure is a metric used to relate the lethality of an electric shock to the duration and magnitude of a current pulse flowing through the body. One metric used to describe this relationship by electrophysiologists is known as the chronaxie; a concept similar to what engineers refer to as the system time constant. Electrophysiologists determine a nerve's chronaxie by finding the minimal amount of electrical current that triggers a nerve cell using a long pulse. In successive tests, the pulse is shortened. A briefer pulse of the same current is less likely to trigger the nerve. The chronaxie is defined as the minimum stimulus length to trigger a cell at twice the current determined from that first very long pulse. A pulse length below the chronaxie for a given current will not trigger a nerve cell. The invention of this disclosure takes advantage of the chronoxie principle to keep the magnitude and duration of the energy packet to be safely below the level that could cause Electrocution.

Electrocution is the induction of a cardiac arrest by electrical shock due to ventricular fibrillation (VF). VF is the disruption of the normal rhythms of the heart. Death can occur when beating of the heart becomes erratic, and blood flow becomes minimal or stops completely. McDaniel et. Al. in the paper “Cardiac Safety of Neuromuscular Incapacitating Defensive Devices”, Pacing and Clinical Electrophysiology, January 2005, Volume 28, Number 1, provides a conservative reference for estimating the minimum electrical charge necessary to induce VF under conditions similar to those of the disclosed invention. The study was performed to investigate the safety aspects of electrical neuromuscular incapacitation devices commonly used by law enforcement agencies for incapacitating violent suspects. McDaniel measured the response of a series of pigs to multiple, brief (150 μs) electrical pulses applied to the thorax of the animals. In these tests, a threshold charge of 720 μC could induce VF in a 30 kg animal. The barbed darts were placed on the surface of the animal in close proximity to the heart and penetrated enough to bypass the normal insulating barrier of the skin. This results in a body resistance as low as 400 Ohms. In comparison, the U.S. Occupational Safety and Health Agency (OSHA) describes the resistance of wet human skin to be approximately 1000 Ohms.

By carefully monitoring the transfer of electrical energy contained sent by a source to a load device, it can be determined if some other mechanism, such as an external short circuit, or person receiving a shock, has affected the transfer of energy. The transfer can then be interrupted to protect the equipment or personnel. If the period of a current pulse is below the muscle chronaxie, human skeletal or heart muscles will be much less affected by the pulse. The avoidance of a building or equipment fire is also critical, but the level of energy to cause a fire is normally much less than that which would cause cardiac arrest. The disclosed invention monitors and controls the transfer of energy in small increments, and thus offers additional safety over what can be provided even by the combination of a circuit breaker and a ground fault interrupter.

There are two primary fault modes that must be detected. The first mode is an in-line or series fault where an abnormal resistance is put in series with the path between the source and load as is illustrated by the individual being shocked in FIG. 3a. The second fault mode is a cross-line or parallel fault as is illustrated in FIG. 3b. The in-line fault can be detected by an abnormal drop in voltage between the source and load points for a given electrical current. In the disclosed invention, the cross line fault is detected by a reduction in impedance between the output conductors after the contacts are isolated from both the source and the load by switches.

### SUMMARY OF THE INVENTION

A block diagram of the present invention is shown in FIG. 1. The power distribution system regulates the transfer of energy from a source 1 to load 3. Periodically, source controller 5 opens S1 disconnect switch 7 for a predetermined time period known as the “sample period”. Capacitor C_{load} 4 is electrically connected to the source terminals by their interface to the load terminals. The capacitor will store the voltage present on source terminals 31a, 31b that existed just prior to the moment that S1 is opened. The resistance between the source terminals is represented by R_{src} 2. In the preferred embodiment, R_{src} has a value between 10 thousand to 10 million Ohms. During normal conditions, when S1 is opened, the voltage across capacitor C_{load} will decay as it discharges through R_{src} and into the load. Load Controller 9 senses the drop in voltage stored by capacitor C_{load} at load terminals 32a, 32b, which are electrically in contact with source terminals 31a, 31b, and immediately commands S2 load disconnect switch 13 to an open state. At this point S1 and S2 are in an open, non-conducting state, electrically isolating the source terminals and load terminals from both the source and the load. The only discharge path for the capacitance represented by C_{load} should be the source terminal resistance R_{src}. However, during a cross-line fault, depicted in FIG. 3b, the resistance of a foreign object such as a human body or conductive element is introduced and is represented by Rₗₑₐₖ 6. The parallel combination of R_{src} and Rₗₑₐₖ will increase the voltage decay rate of C_{lload} significantly. The voltage on C_{load} just prior to S1 and S2 being opened is measured by Source Controller 5. At the end of the predetermined sample period, just prior to where S1 and S2 are commanded back to a closed (conducting) state, the voltage of C_{load} is measured again and compared to the measurement that was made just prior to the beginning of the sample period. If the voltage across C_{load} has decayed either too quickly or too slowly, a fault is registered and S1 and S2 will not be returned to a closed position. A high decay rate indicates a cross-line fault depicted in FIG. 3b. A low decay rate indicates an in-line fault depicted in FIG. 3a. In a distribution system where DC power is being transferred, the difference in voltage decay rate on C_{load} during normal operation and when there is a cross-line fault is depicted in FIG. 4. In a distribution system where AC power is being transferred, the difference in voltage decay rate on C_{load} during normal operation and when there is a cross-line fault is depicted in FIG. 5.

If there are no fault conditions, S1 is again commanded to a closed (conducting) state. The load controller senses the rapid increase in voltage across capacitor C_{load} and immediately closes load disconnect switch S2. Energy is then transferred between the source and load until the next sample period. The conducting period between sample periods is referred to as the “transfer period”.

An additional check for the in-line fault depicted in FIG. 3a is where the source and load controllers acquire their respective terminal voltages at sensing points 34,35 of FIG. 1 after S1 and S2 have been returned to a closed (conducting) state. The source controller obtains the load terminal voltage through the communication link and calculates the voltage difference between the two measurements. The source controller also acquires the electrical current passing through the source terminals using current sensing means 8. The source controller can now calculate the line resistance between the source and load terminals using Ohms law, or the relationship: Resistance=Voltage/Current. The calculated line resistance is compared to a predetermined maximum and minimum value. If the maximum is exceeded, S1 and S2 are immediately opened and an in-line fault is registered. A line resistance that is lower than expected is an indication of a hardware failure. S1 and S2 are immediately opened and a hardware fault is registered.

### BRIEF DESCRIPTION OF THE DRAWINGS

FIG. 1 is a block diagram of the disclosed safe power distribution system

FIG. 2 is a more detailed block diagram of the source controller.

FIG. 3a is a diagram depicting an in-line, or series shock hazard

FIG. 3b is a diagram depicting a cross-line of parallel shock hazard.

FIG. 4 is a diagram showing the voltage on the power distribution system output conductors with a direct current (DC) source

FIG. 5 is a diagram showing the voltage on the power distribution system output conductors with an alternating current (AC) source

FIG. 6a is a diagram of a DC disconnect switch constructed using a uni-directional switch arrangement with blocking diode.

FIG. 6b is a diagram of an AC disconnect switch constructed using a bi-directional switch arrangement.

FIG. 7 is a diagram of an alternate source controller configuration that includes a modulator/demodulator means for communications over power lines.

### DETAILED DESCRIPTION AND OPERATION OF THE PREFERRED EMBODIMENTS

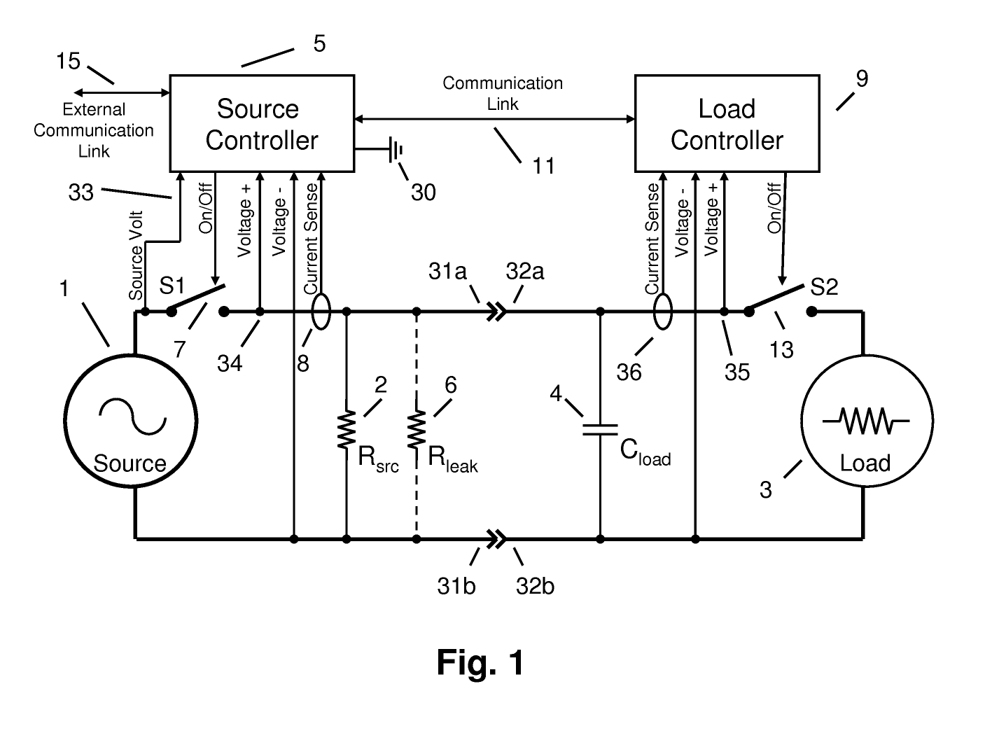

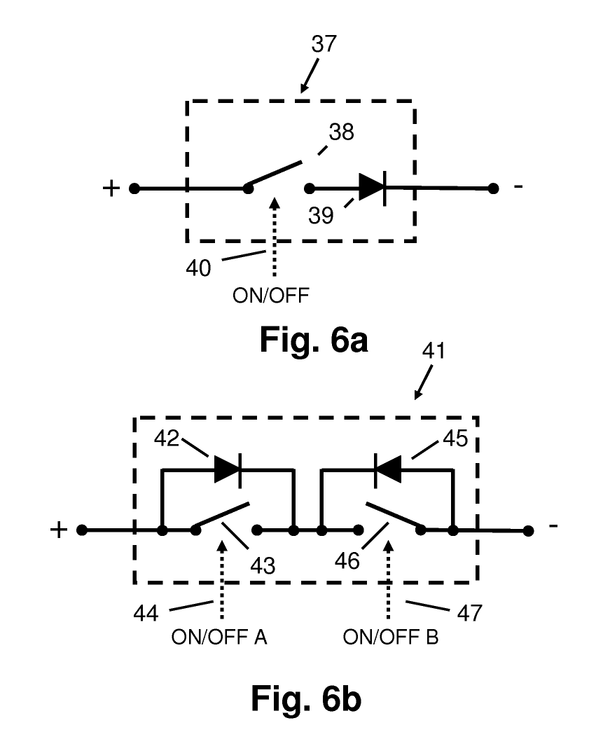

There are a number of industry standard methods for constructing the S1 and S2 disconnect switches 7, 13 of FIG. 1. In the preferred embodiment a different arrangement is employed depending on if the system is distributing DC or AC power. For DC power distribution, DC disconnect switch arrangement 37 of FIG. 6A is preferred. In this arrangement electrical current is blocked in the minus to positive direction by blocking diode 39. Current flow in the positive to negative direction is controlled by internal switch 38 according to the application of control signal 40. The transistor type used for internal switch 38 is chosen based on the electrical voltage and current requirements. Industry standard transistors would include FETs, IGBTs or IGCTs. The electrical implementation of control signal 40 for controlling the conduction of internal switch 38 is dependent on the type of transistor but is well known to those skilled in the art of power electronics.

For AC power distribution, AC disconnect switch arrangement 41 of FIG. 6b is preferred. In this arrangement, internal switches 43 or 46 acting independently can block electrical current in only one direction; since current flow in the opposite direction of each switch is allowed by bypass diodes 42 or 45. However, by the combined action of ON/OFF control signals 44, 47 electrical current through disconnect switch 41 can be blocked in either direction or both directions. To block current in both directions, control signals 44, 47 are both set to the OFF state, placing internal switches 43, 46 in an open (non-conducting state). To allow current flow in the positive to negative direction, but block the negative to positive direction, internal switch 46 is placed in a closed (conducting) state. Electrical current is then free to flow from the positive terminal through bypass diode 42, through internal switch 46 and out the negative terminal. Conversely, to allow current flow in the negative to positive direction, but block the positive to negative direction, internal switch 43 is placed in a closed (conducting) state. Electrical current is then free to flow from the negative terminal through bypass diode 45 through internal switch 43 and out the positive terminal. The transistor types used to implement internal switches 43, 46 are chosen based on the electrical voltage and current requirements. Industry standard transistors would include FETs, IGBTs or IGCTs. The electrical implementation of control signals 44, 47 for controlling the conduction of internal switches 43, 46 is dependent on the type of transistors used, but is well known to those skilled in the art of power electronics.

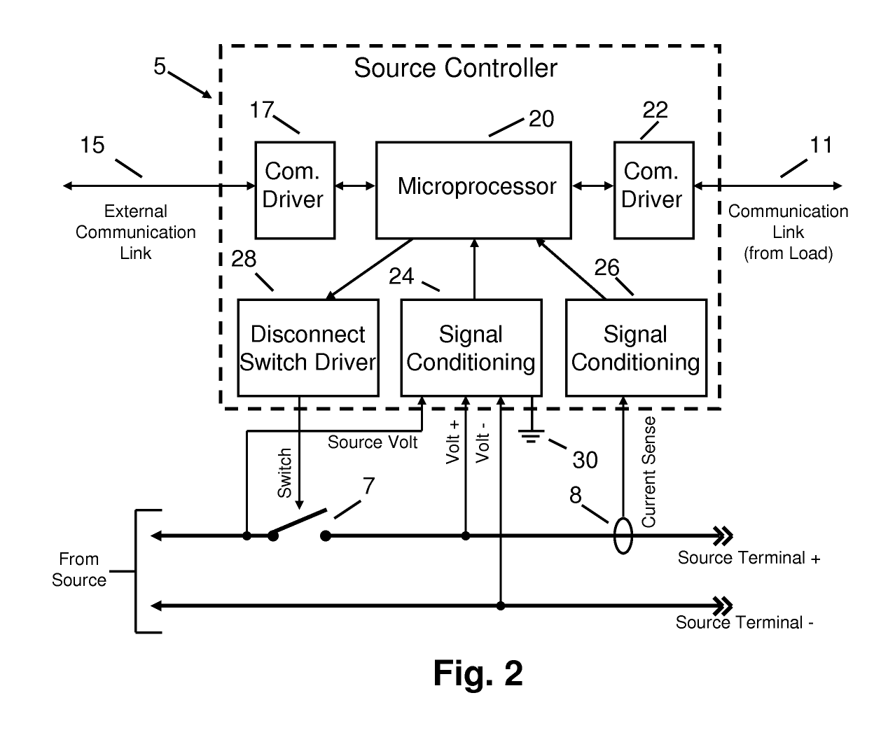

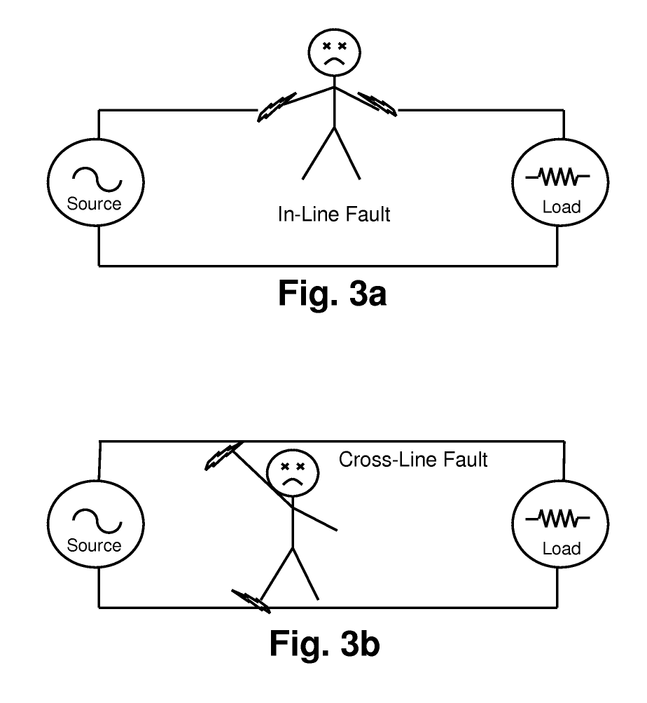

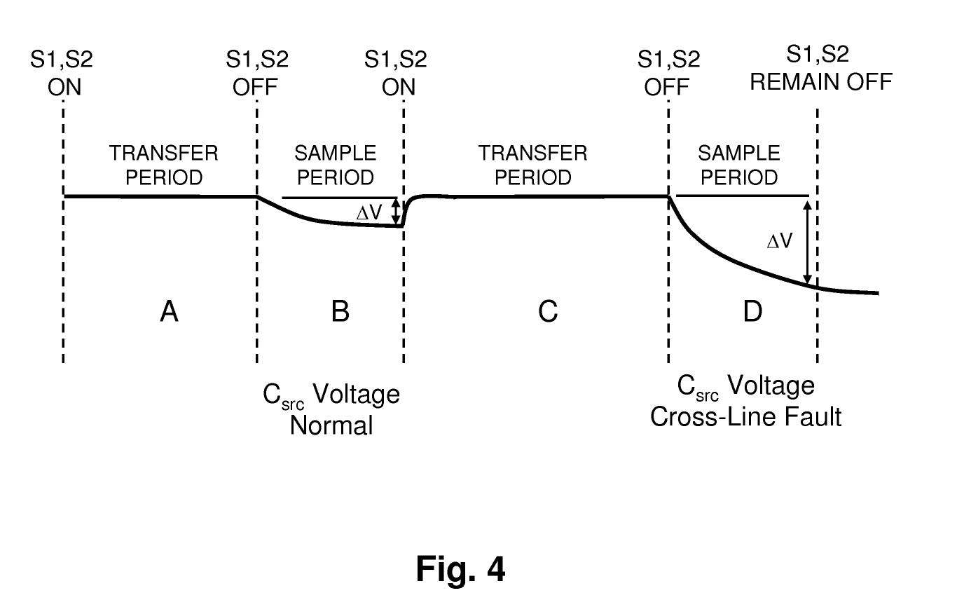

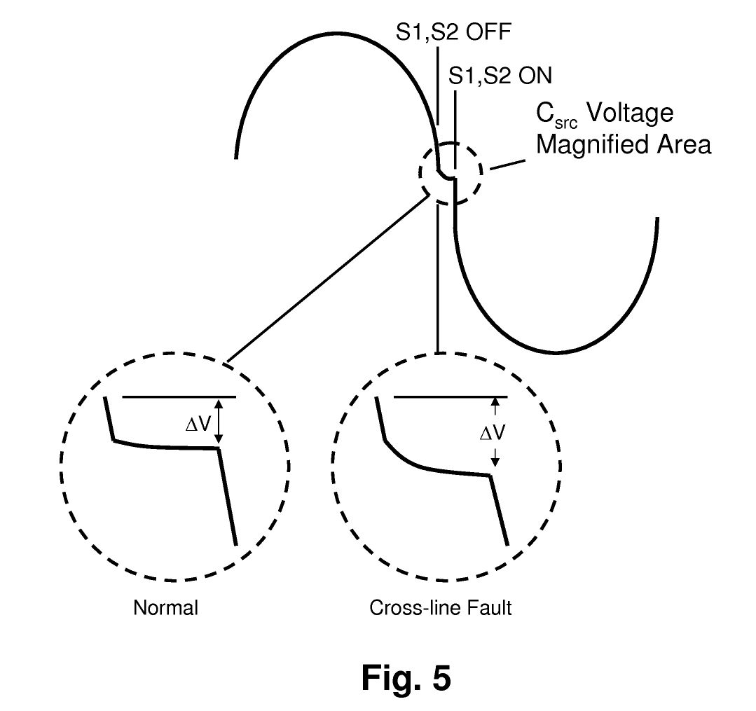

As shown in FIG. 2, source controller 5 includes Microprocessor 20, Communication Drivers 17, 22 and signal conditioning circuits 24, 26, 28. Load Controller 9 of FIG. 1 is nearly identical in construction to the source controller but is configured with different operating software to perform the functions described in the Operation Sequence section below. Referring to FIG. 1, before beginning operation, self-check and initialization steps are performed in steps (a) and (b). S1 disconnect switch 7 and S2 disconnect switch 13 remain in an open (non-conducting) state during initialization.

### Operational Sequence

a) Referring to FIG. 1, Source Controller 5 verifies that the source voltage at point 33 is within a predetermined expected value and that there is no current flowing in the source power conductors as reported by Current Sensing Means 8. The source controller also performs built-in testing algorithms, typical to the industry, to verify that its hardware and firmware is functioning properly.
b) A communication check is performed by the source controller through communication link 11 to load controller 9. For distribution systems that provide secured energy transfer, the source controller will request a verification code to ensure that the source and load equipment is electrically compatible and authorized to receive power. Such verification would be necessary for applications where the energy is being purchased, for example. The source controller sends a request via communication link 11 to the load controller asking it for status. The load controller should respond with the value of voltage and current on its conductors and any fault codes. The source controller verifies that the load voltage is within a predetermined value and that there is no current flowing in the load power conductors (indicating a possible failed source disconnect, failed current sensors or other hardware problem). The load controller also performs built-in testing algorithms, typical to the industry, to verify that its hardware and firmware are functioning properly. Any problems in the load hardware are sent as a fault code through the communication link to the source controller. If there is no fault registered, the sequence progresses to step (c), otherwise the sequence skips to step (j).
c) Source controller 5 makes another measurement of the source voltage at point 33 to determine the duration of the transfer period, where energy will be transferred from the source to the load. The duration of the transfer period is calculated to fall below the chronaxie value for a child given the source voltage measured and a worst case wet skin resistance of 1,000 Ohms. The higher the source voltage, the higher the potential fault current, and hence the shorter the transfer period. The source voltage measurement is applied to an internal table or function in the source controller processor that is representative of the time-intensity curve of human muscle tissue. A variable transfer period allows the controller to integrate the sensed voltage and current over a longer period and thus make a more accurate determination of the state of the system while being less sensitive to electrical noise and sensor inaccuracy. The use of variable transfer period is not required for the operation of the disclosed invention, but will make energy transfer more efficient and less prone to false alarms. The alternative is to maintain a very short, fixed duration transfer period that is configured for the highest possible source voltage and worst case safety conditions. For simple low cost systems, preferably at lower voltage levels, a fixed transfer period may be the correct choice.
d) Following the determination of the transfer period the source controller closes switch S1. The load controller senses the rapid increase in voltage across capacitor C_{load} 4 at voltage sensing point 35, and immediately closes switch S2 13. Both controllers continue to measure voltage and current at their respective terminals.
e) The source controller calculates the difference between the source terminal voltage measured at point 34 and the load terminal voltage at point 35 reported by the load controller through communication link 11. The difference is divided by the source current as measured by current sensing means 8 and results in a calculated value of line resistance between the source and load terminals. If the line resistance is greater than a predetermined maximum value, the source controller immediately opens S1 and sends a command over communication link 11 to open S2. An in-line fault is then registered by the source controller. A calculated line resistance less than a predetermined minimum value is indicative of a hardware failure. In this case, the source controller acts to open S1 and S2 immediately and a hardware fault is registered. If there are no faults registered, the sequence progresses to step (f), otherwise the sequence skips to step (j).
f) At the end of the transfer period, the sample period begins. The source controller and measures the voltage across C_{load} at point 34 and then opens switch S1. The load controller senses the rapid decrease in voltage across C_{load} when S1 is opened and immediately opens switch S2. The current through the source and load terminals after S1 and S2 are opened is measured by current sensing means 8, 36. If the current values are not approximately zero, a hardware fault is registered, disconnect switches S1 and S2 are left in an open state, and the sequence skips to step (j). If there is no fault registered, the operational sequence continues to step (g).
g) Switches S1 and S2 remain in the open state until the end of the sample period. At the end of the sample period, the source controller measures the voltage of C_{load} at point 34, and compares the voltage reading to the voltage reading that was acquired just prior to the beginning of the sample period. If the voltage has decayed too quickly by being less than a first predetermined value, then a cross-line fault is registered. If it has decayed too slowly and has failed to drop to less than a second predetermined value, an in-line fault is registered. If there are no faults registered, the operational sequence continues to step (h) otherwise the sequence skips to step (j).
h) Switch S1 is closed by the source controller but switch S2 remains in an open state. After a predetermined time delay, the source controller measures the voltage of C_{load} at point 34 and calculates the difference between that reading and the previous voltage reading that was acquired at the end of the sample period in step (g). If the voltage has risen too quickly by the difference exceeding a first predetermined value, then an in-line fault is registered. If the voltage has risen too slowly by the difference being less than a second predetermined value, a cross-line fault is registered. If there are no faults registered, switch S2 is closed by the source controller and the operational sequence continues to step (i) otherwise the sequence skips to step (j).
i) If there are no faults registered, the operational sequence repeats starting at step (c), otherwise the sequence continues at step (j).
j) The power distribution is in a faulted state due to an in-line fault, cross-line fault or hardware failure. In the preferred embodiment, the system will allow configuration of either an automatic reset or manual reset from a faulted state. If the system is configured for manual reset, it will remain with the S1 and S2 switches open until an outside system or operator initiates a restart. It will then restart the operational sequence from step (a). If the system is configured for automatic restart, then a delay period is executed by the source controller to limit stress on equipment or personnel that may still be in contact with the power distribution conductors. In the preferred embodiment, the period is from 1 to 60 seconds. The system then restarts the operational sequence from step (a). For an additional level of safety, mechanical contactors could also be included in series with S1 and/or S2 to act as redundant disconnects in the event that S1 and S2 fail.

### SUMMARY, RAMIFICATIONS AND SCOPE

The present invention provides a novel power distribution system that can safely transfer energy from a source to a load while overcoming the deficiencies of conventional circuit protection devices and ground fault interrupters.

In its simplest form, the present invention could be configured to only sense a cross-line fault such as would occur if an individual simultaneously touches both link conductors. In this case only the voltage across the source terminals in position 34 of FIG. 1 would need to be measured to recognize the fault.

In the preferred embodiment a “sample period” is initiated by opening source disconnect switch S1 7 of FIG. 1. Load controller 9 senses the rapid voltage drop on C_{load} when S1 is opened and immediately opens disconnect switch S2 13 to begin the sample period. Using communication link 11, the action of opening S2 could be initiated by the source controller sending a communication command to the load controller and the load controller commanding the load disconnect device to an open or closed state rather than having the load controller sense the voltage drop on C_{load} as the trigger to open the load disconnect device.

The components C_{load} 4 and R_{src} 2 of FIG. 1 represent the capacitance and resistance as seen at the source 31a, 31b and load terminals 32a, 32b when switch S1 7 and S2 13 are in an open (non-conducting state). In the preferred embodiment, these components would be discrete components, of known value, placed across the source and load terminal conductors. However, the capacitance and resistance of the conductors, even without the discrete components, would have an intrinsic value of resistance and capacitance due to their physical construction. In some instances, the system could be operated by programming the source controller with these intrinsic values, thus negating the requirement to install discrete resistor and capacitor components.

In some applications, energy may flow from the load device to the source device as exemplified in a “grid connected” application such as a home with an alternative energy sources such as a photovoltaic solar array. At night, the home would act as the load device with the utility grid being the source of energy, but during the day the home may become a source rather than a load when it generates solar electricity to be sold back to the grid. In such a case, the operation of the system would be essentially the same as what was described above in the detailed description of the preferred embodiment. Since the source and load controllers detect both the magnitude and polarity of the electrical current and voltage within the power distribution system, the source controller would inherently start executing this new mode of operation. For example, as described in the detailed operation section, the voltage drop in the power distribution system conductors is calculated by multiplying the line current by a worst case line resistance. When the load starts supplying power rather than sinking power, the polarity of electrical current will reverse and the line drop calculation will still be valid.

Source Controller 5 and Load Controller 9 could contain a microprocessor, microcontroller, programmable logic device or other suitable digital circuitry for executing the control algorithm. The load controller may take the form of a simple sensor node that collects data relevant to the load side of the system. It does not necessarily require a microprocessor.

The source and load controllers could be used to meter energy transfer and communicate the information back to the user or a remote location. For example, the disclosed invention could be implemented on an electric vehicle public charging station and could be utilized to send electricity consumption back to a central credit card processor. The transfer of information could be through Outside Communication Link 15 as depicted in FIG. 1. A user could also be credited for electricity that is transferred from his electric vehicle and sold to the power grid. The outside communication link could also be used to transfer other operational information. For example, an electric vehicle could have contacts under its chassis that drop down make connection to a charging plate embedded in a road surface. The communication link could transfer proximity information indicating that the car is over the charging plate. The information could inhibit energizing the charger plate unless the car is properly positioned.

The source disconnect device could be supplemented by the addition of an electromechanical relay or “contactor” providing a redundant method to disconnect the source from the source terminals that would provide a back-up in the case of a failure of the source disconnect device. The load disconnect device could be supplemented by an electromechanical relay or contactor in the same fashion. The electromechanical contactor activation coils could be powered by what is known to those skilled in the art as a “watchdog circuit”. The watchdog circuit must be continually communicated with by the source or load controllers, otherwise the contactor will automatically open, providing a fail-safe measure against “frozen” software or damaged circuitry in the controllers.

The source controller could be programmed with an algorithm that would adjust the ratio of time that the source disconnect device is conducting in respect to the time that it is not conducting in order to regulate the amount of energy transfer from the source to the load. This method is well known to those skilled in the art as “pulse width modulation”.

Communication link 11 and or external communication link 15 could be implemented using various methods and protocols well known to those skilled in the art. Communication hardware and protocols could include RS-232, RS-485, CAN bus, Firewire and others. The communication link could be established using copper conductors, fiber optics or wirelessly over any area of the electromagnetic spectrum allowed by regulators. Wireless communication could be established using a number of protocols well known to those skilled in the art that include Wi-Fi, IRDa, Wi-Max and others.

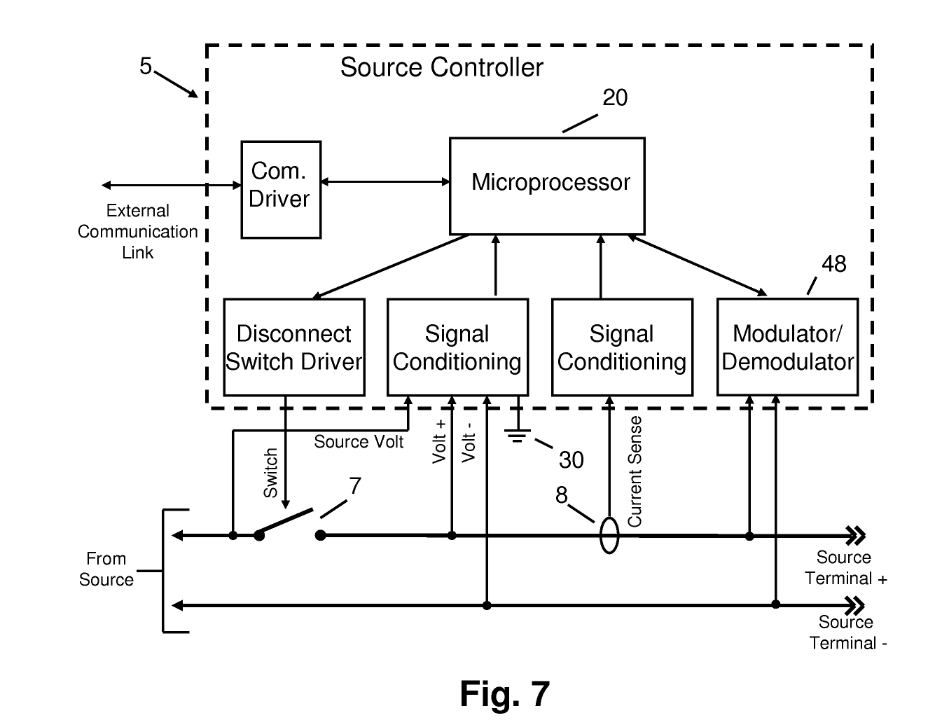

Another option for implementing the functions of communication link 11 and/or external communication link 15 of FIG. 1 would be what is referred to those skilled in the art as “communication over power lines”, or “communication or power line carrier” (PLC), also known as “Power line Digital Subscriber Line” (PDSL), “mains communication”, or “Broadband over Power Lines” (BPL). Referring to the revised source controller of FIG. 7, communication signals generated by microprocessor 20 are superimposed on the source terminals using modulator/demodulator means 48. The hardware and software methods of modulator/demodulator 48 are well known to those skilled in the art. Although the source controller is used as an example, an identical implementation of the modulator/demodulator means would be contained in the load controller, allowing bidirectional communication between the source and load controller. The transmitting side, either the source or load, would combine the communication signals with the power waveform on the source or load terminals. The receiving side, either the source of the load, would then separate the communication signals from the power waveform.

Thus the scope of the disclosed invention should be determined by the appended claims and their legal equivalents, rather than the examples given.

1) A power distribution system for regulating the transfer of energy from a source to a load comprising:
a) source controller means on the source side of said power distribution system responsive to sensing means that provides feedback to the source controller that includes at least a signal indicative of the voltage across the source terminals;
b) source disconnect device means responsive to a control signal from the source controller for electrically connecting or disconnecting the source from the source terminals;
c) load controller means on the load side of said power distribution system responsive to sensing means that provides feedback to the load controller that includes at least a signal indicative of the voltage across the load terminals;
d) load disconnect device means responsive to a control signal from the load controller for electrically connecting or disconnecting the load from the load terminals;
e) logic means implemented in at least the source controller for determining, based on a predetermined set of conditions that includes at least if the change in voltage across the source terminals in respect to time falls outside a predetermined range, if the source disconnect device should be opened to interrupt the electrical connection between the source and source terminals.

2) The power distribution system of claim 1 that includes data communication means for the exchange of operating information between the source controller and load controller that includes at least a value indicative of the voltage across the load terminals that is acquired by the load controller.

3) The power distribution system of claim 2 where the data communication means is comprised of wireless communication circuits operating at carrier frequencies within the electromagnetic spectrum allowed by federal regulators.

4) The power distribution system of claim 2 where the data communication is accomplished by modulator/demodulator means in the source and load controllers that are operable to combine a communication signal with the voltage waveforms present on the source or load terminals, or separate a communication signal from the voltage waveforms present on the source or load terminals, such that the source and load controller can communicate with each other using only the connections between the source and load terminals and no separate dedicated communication line is necessary.

5) The power distribution system of claim 2 where the source and load controller exchange a digital verification code that must match a predetermined value before energy transfer can be initiated.

6) The power distribution system of claim 1 where the source disconnect device is responsive to a control signal from the source controller to vary the ratio of time that the source is connected to the source terminals in relationship to the time the source is disconnected from the source terminals thereby providing the means to regulate the average energy transferred from the source to the load.

7) The power distribution system of claim 1 where a current sensing means is included that allows the source controller to acquire a signal indicative of the electrical current flowing from the source to the source terminals and where the source controller can act to open the source disconnect device to disconnect the source from the source terminals if the electrical current exceeds a predetermined maximum value.

8) The power distribution system of claim 1 where the source controller calculates the difference between the source terminal voltage acquired by the source controller and the load terminal voltage acquired by the load controller and acts to open the source disconnect device if the difference does not fall between predetermined high and low values.

9) The power distribution system of claim 7 where the source controller periodically multiplies the source terminal voltage measurements with the source current measurements resulting in a calculated instantaneous power value, and where consecutive power values are integrated with respect to time to derive a total energy value, and where the total energy value may be used as information for the user or for the purposes of applying a financial charge to the user for energy extracted from the source.

10) A method for implementing a power distribution system for the transfer of energy from a source to a load, where the power distribution system can detect unsafe conditions that include electrically conducting foreign objects or individuals that have come in contact with exposed power distribution system conductors, the method comprising the steps of:
a) executing an algorithm in the source controller to acquire a first measurement of the voltage across the source terminals using source terminal voltage sensing means, and storing the first voltage measurement in the memory a source controller;
b) executing algorithms in the source controller and a load controller to generate signals responsive to open a source disconnect device means and a load disconnect device means, resulting in the interruption of the electrical connection between the source and the source terminals and from the source terminals to the load;
c) after a predetermined time has expired, acquiring a second measurement of the voltage of the source terminals using the source terminal voltage sensing means and storing the second voltage measurement in the memory of the source controller;
d) executing an algorithm in the source controller to calculate the mathematical difference between the first stored voltage measurement and the second stored voltage measurement, where the mathematical difference represents the discharge rate of the capacitance as seen across the source and load and terminals;
e) generating signals from the source controller to close the source disconnect device means and the load disconnect device means only if the discharge rate of the capacitance falls within a predetermined set of values, and where a discharge rate outside of the predetermined set of values indicates that there is a conducting foreign object or individual making electrical contact with the source or load terminals, or a failure in the power distribution system hardware.

11) The method of claim 10 where a digital verification code is stored in the load controller, and where the source controller communicates with the load controller using optical, conductive or wireless communication means to acquire the digital verification code, and will act to cause the source disconnect means to remain in an open state if the digital verification code does not match a previously stored copy resident in the source controller memory.

12) The method of claim 10 where the source controller acts to vary the conductive time period of the source disconnect device means in relation to the non-conductive time period of the source disconnect device means such that the average energy transferred from the source to the load can be regulated according to an algorithm being executed by the source controller.

13) The method of claim 10 including the steps of executing an algorithm in the source controller to acquire a value indicative of the electrical current flowing through the source terminals using current sensing means, and storing the electrical current value in the source controller memory, and where the source controller acts to open the source disconnect device to disconnect the source from the source terminals if the electrical current exceeds a predetermined maximum value.

14) The method of claim 10 including the steps executing an algorithm in the source controller to calculate the difference between the source terminal voltage acquired by the source controller using the source terminal voltage sensing means and the load terminal voltage acquired by the load controller using load terminal voltage sensing means, and acting to open the source disconnect device if the difference does not fall between predetermined high and low values.

15) The method of claim 13 where the source controller executes an algorithm to periodically multiply the source terminal voltage measurements by the source current measurements resulting in an instantaneous power value, and where consecutive calculated power values are integrated with respect to time to derive a total energy value, and where the total energy value may be used as information to the user or for the purposes of applying a financial charge to the user for power extracted from the source.

16) The method of claim 10 where after determining that the discharge rate of the capacitance as seen across the source and load terminals is within a predetermined set of values and a signal is generated by the source controller to close the source disconnect device means, the method of claim 10 is revised to leave the load disconnect device means in an open state, and the following steps are implemented:
a) after a predetermined time has expired, an algorithm is executed in the source controller to acquire a third measurement of the voltage across the source terminals using the terminal voltage sensing means and the third voltage measurement is stored in the memory of the source controller;
b) an algorithm is executed in the source controller to calculate the mathematical difference between the second stored measurement of claim 10 and the third stored voltage measurement of the present claim, where the mathematical difference represents the recharge rate of the capacitance as seen across of the source and load terminals;
c) the source controller acts to close the load disconnect device means only if the recharge rate of the capacitance is within a predetermined set of values, and where a recharge rate not within the predetermined set of values indicates that there is a conducting foreign object or individual making electrical contact with the source or load terminals or a failure in the power distribution system hardware.
